(19) United States
(12) Patent Application Publication
(10) Pub. No.: US 2007/0097806 A1
(43) Pub. Date: May 3, 2007

(54) Disk drive that compensates for track radial pitch variation and methods thereof

(75) Inventors: Orhan Beker, Rancho Santa Margarita, CA (US); Bernie Rub, Sudbury, MA (US); John Hawk, Shrewsbury, MA (US)

Correspondence Address: David K. Purks;Myers Bigel Sibley & Sajovec, P.A., P. O. Box 37428, Raleigh, NC, 27627, US

(73) Assignee: Maxtor Corporation

(21) Appl. No.: 11/500,691

(22) Filed: Aug. 8, 2006

Related U.S. Application Data
(60) Provisional application No. 60/733,074, filed on Nov. 3, 2005.

(51) Int. Cl. G11B 21/08

(52) U.S. Cl. 369/30.12

(57) ABSTRACT

A disk drive includes a rotatable data storage disk having a plurality of radially distributed tracks, and where radial pitch between at least some of the tracks varies across the disk. A head is configured to read/write data on the tracks. An actuator is configured to position the head relative to the disk. A controller is configured to respond to a host read/write command identifying a track address on the disk by determining a corresponding shifted radial location on the disk that is radially offset from an actual location of the addressed track by a distance that at least partially compensates for the radial pitch variation between at least some of the tracks on the disk. Corresponding methods are disclosed for positioning a head that is adjacent to a rotatable disk in a disk drive so as to at least partially compensate for radial pitch variation between at least some of the tracks on the disk.

### RELATED APPLICATION

This application claims the benefit of and priority to U.S. Provisional Patent Application No. 60/733,074, filed Nov. 3, 2005, the disclosure of which is hereby incorporated herein by reference as if set forth in its entirety.

### FIELD OF THE INVENTION

The present invention relates to disk based storage devices and, more particularly, to positioning heads based on servo burst patterns on a disk.

### BACKGROUND OF THE INVENTION

A simplified diagrammatic representation of a disk drive, generally designated as 10, is illustrated in FIG. 1. The disk drive 10 includes a data storage disk 12 that is rotated by a spindle motor 14. The spindle motor 14 is mounted to a base plate 16. An actuator arm assembly 18 is also mounted to the base plate 16.

The actuator arm assembly 18 includes a read/write head 20 mounted to a flexure arm 22 which is attached to an actuator arm 24 that can rotate about a pivot bearing assembly 26. The actuator arm assembly 18 also includes a voice coil motor (VCM) 28 which moves the head 20 relative to tracks defined on the disk 12. The spindle motor 14, VCM 28, and head 20 are coupled to a number of electronic circuits 30 mounted to a printed circuit board 32. Although a single disk 12 is illustrated in FIG. 1, the disk drive 10 may instead include a plurality of disks with a head adjacent to each disk storage surface to read/write therefrom.

FIG. 2 is an exemplary top view of the disk 12. Data is stored on the disk 12 within a number of concentric tracks 40 (or cylinders). Each track is divided into a plurality of radially extending sectors 42 of the disk 12. Each sector 42 is further divided into a servo sector 44 and a data sector 46. Information in the servo sectors 44 is used to, among other things, accurately position the head 20 so that host data can be properly written onto and read from the data sectors 46.

FIG. 3 illustrates exemplary servo information 73 that can be stored in each of the servo sectors 44. The servo information 73 can include a DC erase field 731, a preamble field 732, a servo address mark (SAM) field 733, a track number field indicated by its least significant bits (LSBs) 734, a spoke number field 735, an entire track number field 736 which is recorded in at least one of the servo sectors 44, and a servo burst field 737 of circumferentially staggered radially offset servo bursts (e.g., A, B, C, D servo bursts). The DC erase field 731 can indicate to the circuits 30 the onset of a servo sector 44. The preamble 732 may be used by timing and gain loops in the circuits 30 to establish a gain and phase lock relationship for sampling the analog signal that is generated when reading the servo information through the head 20.

A servo controller in the electronic circuits 30 determines the position of the head 20 relative to the tracks 40 in response to the servo information read from the servo sectors 44. The servo controller uses the determined position to move the head 20 from an initial track to a target track (i.e., seek operation), and to maintained the head 20 aligned with the target track while data is read/written on the disk 12 (i.e., track following operation). During a seek operation, the track addresses are used as coarse positioning information to estimate the position of the head 20 as it is moved to the target track. During track following, the servo bursts are used as fine positioning information to precisely align the head 40 over the selected track.

A servo track writer (STW) can be used to the write the servo information 73 in the servo sectors 44 during a manufacturing process. To form the data tracks 40 across the disk 12, the STW controls each head 20 to write servo information at locations that are distributed across the disk 12 with incremental radial steps (pitch) therebetween. An attempt is made to write the servo information 73 with a constant pitch, so that the resulting data tracks 40 will have a constant pitch across the disk 12. As used herein, the term “pitch” is the radial distance between centers of adjacent regions on the surface of a disk 12. For example, track pitch 48 (shown in FIG. 2) is the distance between the centers of two radially adjacent tracks 40.

During manufacturing, an attempt may be made to correct excessive track pitch variation by identifying the addresses for groups of tracks that have insufficient track pitch or excessive track pitch, and storing those track addresses in a table. Track addresses listed in the table are then not used during operation of the disk drive, which can be referred to as the tracks being “mapped out”.

The continuing need for higher capacity disk drives continues to drive higher track densities (i.e., smaller track pitch). With higher track densities, an acceptable margin for track pitch variation can correspondingly decrease and can cause a greater number of formatted disks to fail qualification tests and/or may result in reduced capacity and performance from the disk drive.

### SUMMARY OF THE INVENTION

In some embodiments of the present invention, a disk drive includes a rotatable data storage disk having a plurality of radially distributed tracks, where the radial pitch between at least some of the tracks varies across the disk. A head is configured to read/write data on the tracks. An actuator is configured to position the head relative to the disk. A controller is configured to respond to a host read/write command identifying a track address on the disk by determining a corresponding shifted radial location on the disk that is radially offset from an actual location of the addressed track by a distance that at least partially compensates for the radial pitch variation between at least some of the tracks on the disk.

Some other embodiments of the present invention are directed to corresponding methods of positioning a head that is adjacent to a rotatable disk in a disk drive, and so as to at least partially compensate for radial pitch variation between at least some of the tracks on the disk.

### DESCRIPTION OF THE DRAWINGS

FIG. 1 is a perspective view of a conventional disk drive.

FIG. 2 is a top view of a conventional disk and illustrates tracks and sectors.

FIG. 3 is a block diagram of conventional servo information fields in a servo sector.

FIG. 4 is a block diagram of a disk drive and illustrates electronic circuits of a disk drive that includes a data controller, servo controller, and a repository of track addresses and corresponding radial offsets in accordance with some embodiments of the present invention.

FIG. 5 is a flowchart of operations for at least partially compensating for radial pitch variation according to some embodiments of the present invention.

FIG. 6 illustrates six reference tracks and corresponding actual tracks that may be defined in data sectors on the disk by servo information in the servo sectors.

FIG. 7 illustrates an exemplary table of track addresses and track offset distances that may be defined by the repository according to some embodiments of the present invention.

FIG. 8 illustrates six reference tracks and corresponding actual tracks having a single track misplacement and which may be defined in data sectors on the disk by servo information in the servo sectors.

FIG. 9 illustrates six reference tracks and corresponding actual tracks having repetitive pairs of track misplacement and which may be defined in data sectors on the disk by servo information in the servo sectors.

FIG. 10 illustrates six reference tracks and corresponding actual tracks with one of the actual tracks being a narrowed track, and which may be defined in data sectors on the disk by servo information in the servo sectors.

FIG. 11 illustrates a portion of the disk on which the radial offset information is distributed across the disk within one or more of the servo sectors and radially aligned with the corresponding data tracks.

FIG. 12 is a flowchart of operations that may be carried out by the servo controller to respond to the radial offset information in the servo information so as to at least partially compensate for radial pitch variation among tracks.

FIG. 13 illustrates methods of micro-jogging the head to a shifted radial location relative to an addressed track N+1 in response to radial offset information in the adjacent servo information, such as that shown in FIG. 11.

### DETAILED DESCRIPTION OF THE INVENTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

It also will be understood that, as used herein, the term “comprising” or “comprises” is open-ended, and includes one or more stated elements, steps and/or functions without precluding one or more unstated elements, steps and/or functions. As used herein, the singular forms “a”, “an” and “the” are intended to include the plural forms as well, unless the context clearly indicates otherwise. The term “and/or” and “/”includes any and all combinations of one or more of the associated listed items. In the drawings, the size and relative sizes of regions may be exaggerated for clarity.

Some embodiments of the present invention can provide disk drives, servo channels, and methods. Accordingly, the present invention may be embodied in hardware and/or in software (including firmware, resident software, micro-code, etc.). Consequently, as used herein, the term “signal” may take the form of a continuous waveform and/or discrete value(s), such as digital value(s) in a memory or register. Furthermore, the present invention may take the form of a computer program product on a computer-usable or computer-readable storage medium having computer-usable or computer-readable program code embodied in the medium for use by or in connection with an instruction execution system.

The present invention is described below with reference to block diagrams and operational flow charts. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

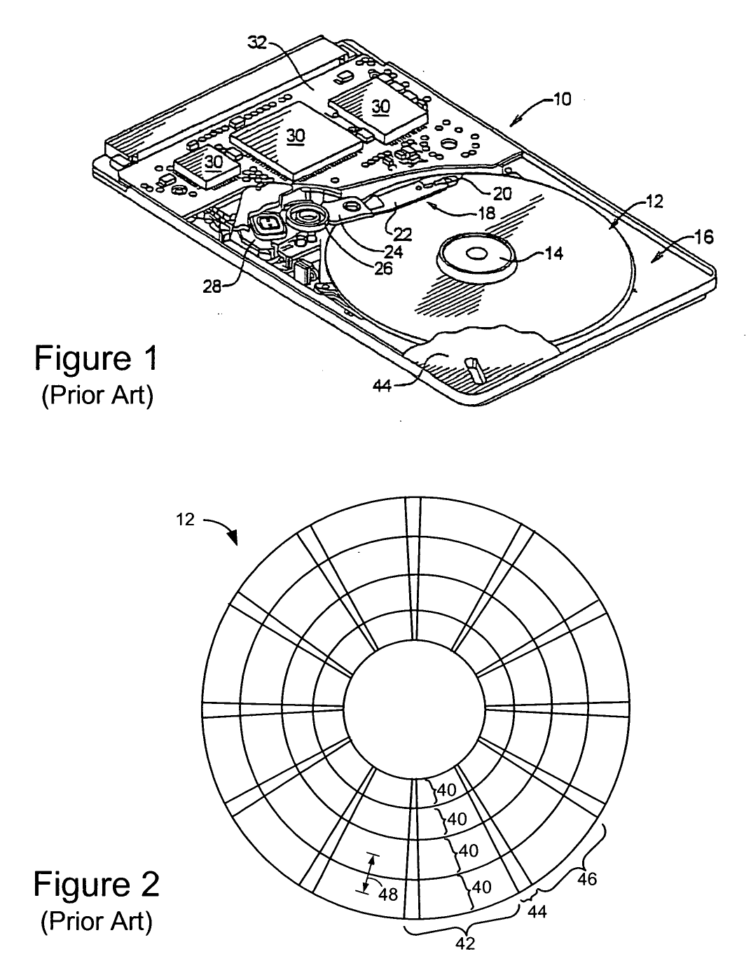

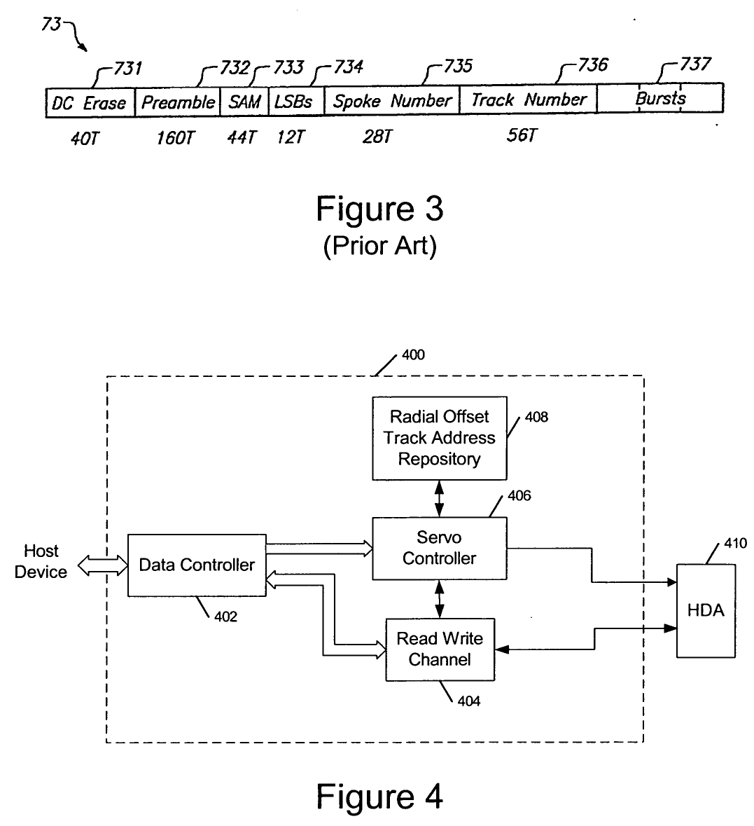

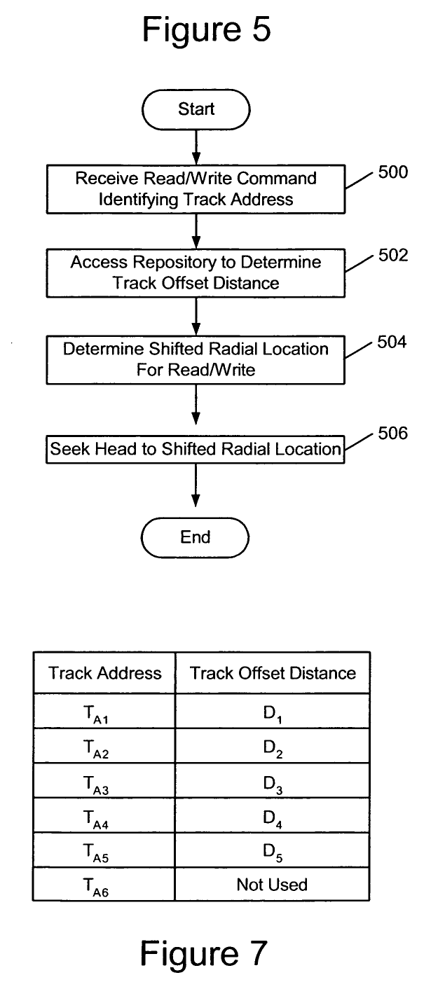

FIG. 4 is a block diagram of electronic circuits 400 of a disk drive, which, for purposes of explanation, can be included within the circuits 30 of disk drive 10 of FIG. 1. The electronic circuits 400 include a data controller 402, a servo controller 406, a read/write channel 404, and a repository 408 of track addresses and radial offset information according to some embodiments of the present information. The exemplary embodiment of the electronic circuits 400 has been illustrated with separate controllers 402, 406, read/write channel 404, and repository 408 for purposes of illustration and discussion only. It is to be understood that their functionality may be consolidated in fewer components or distributed among more and/or other components. The electronic circuits 400 respond to host read/write commands to control the head disk assembly (HDA) 410 to seek the head 20 to a track address and Logical Block Addresses (LBAs) identified by the host read/write command and to read/write data therefrom. The HDA 410 can include the actuator arm assembly 18, the disk(s) 12, the VCM 28, and the spindle motor 14.

The read/write channel 404 can operate in a conventional manner to convert data between the digital form used by the data controller 402 and the analog form conducted through the head 20 in the HDA 410. The read/write channel 404 provides servo positional information read from the HDA 410 to the servo controller 406. The servo positional information can be used to detect the location of the head 20 in relation to LBAs on the disk 12. The servo controller 406 can use LBAs from the data controller 402 and the servo positional information to seek the head 20 to an addressed track and block on the disk 12, and to maintain the head 20 aligned with the track while data is written/read on the disk 12.

The electronic circuits 400 are also configured to at least partially compensate for radial pitch variation between at least some of the tracks on the disk 12, such as variation in pitch 48 between tracks 40 in FIG. 2. For purposes of explanation, the functionality for carrying out the radial pitch compensation is described in the context of being primarily carried out by the servo controller 406, however, it may instead, or in addition, be carried out by the data controller and/or by another electronic component of the disk drive 10.

The servo controller 406 responds to a track address on the disk 12 that is identified by a host read/write command by determining a corresponding shifted radial location on the disk that is radially offset from the track address by a distance that at least partially compensates for radial pitch variation between at least some of the tracks on the disk 12. The repository 408 identifies track addresses and corresponding radial offset information. The servo controller 406 can access the repository 408 using the track address as a lookup pointer to obtain the corresponding radial offset information which may identify a radial distance that the head 20 needs to be moved from the addressed track centerline to at least partially compensate for track pitch variation. The servo controller 406 can determine therefrom the shifted radial location on the disk 12 to read/write data.

The repository 408 may be recorded on the disk 12 in the HDA 410 and/or it may reside in a semiconductor memory device within or otherwise accessible by the electronic circuits 400. Moreover, as will be further explained below, the repository 408 may reside at a reserved location on the disk 12 and/or it may be radially distributed across the disk 12 so that the radial offset information may be recorded at locations that are radially aligned with the corresponding addressed tracks on the disk 12. For example, the radial offset information may be included as part of the servo information within at least one of the servo sectors 44.

exemplary flowchart of operations that may be carried out by the data controller 402 and/or servo controller 406 to at least partially compensate for radial pitch variation. At Block 500, a read/write command from a host device is received. The read/write command identifies a track address on the disk 12. At Block 502, the repository 408 is accessed to determine the track offset distance. At Block 504, a shifted radial location on the disk 12 for performing a read/write operation is determined in response to the commanded track address and the determined track offset distance. At Block 506, the head is moved via a seek operation to the shifted radial location on the disk 12 and data is read/written along that location.

The repository 408 may, for example, identify radial offset information for each track address that has at least a threshold amount of pitch variation. However, identifying radial offset information for each track may result in a high storage space requirement for the repository 408 as the number of tracks on disk 12 increases. Various further embodiments of the present invention are directed to operations and methods for representing the radial offset information that can be used to compensate for radial pitch variation between tracks.

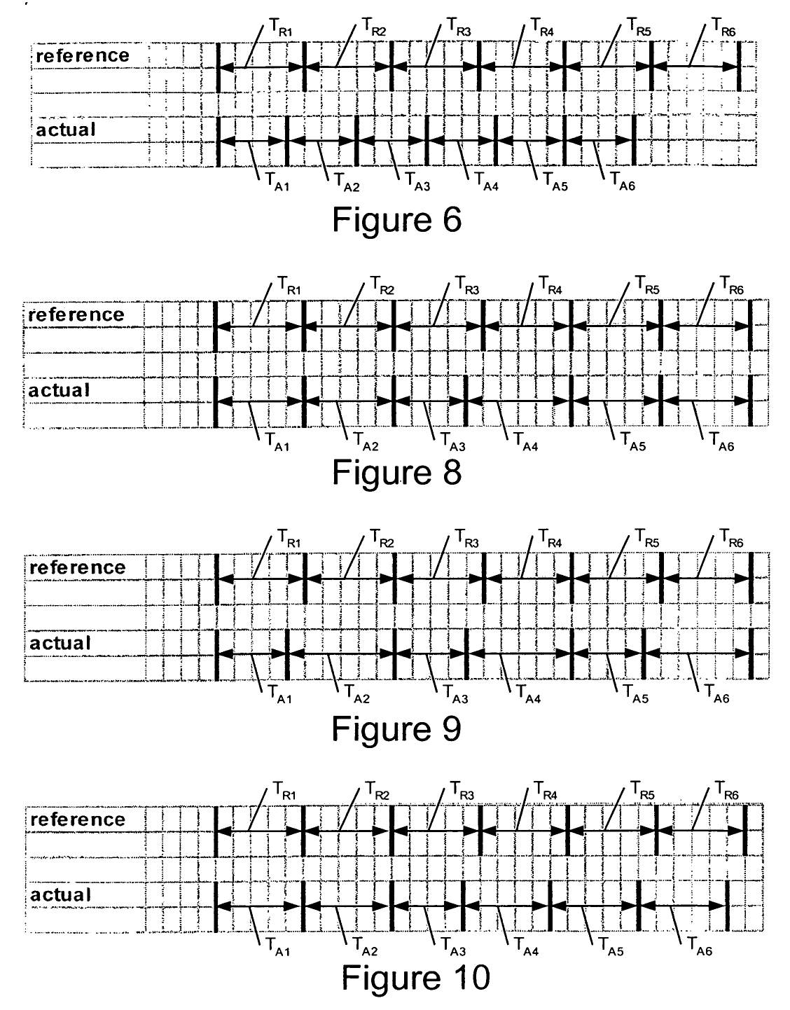

FIG. 6 is a diagram that illustrates six actual tracks and corresponding reference tracks that may be defined in data sectors 46 by servo information in the servo sectors 44. The reference tracks T_{R1} to T_{R6} have the same radial track pitch therebetween and, accordingly, may represent tracks that a STW would preferably form on the disk 12. The actual tracks T_{A1} to T_{A6} represent how the reference tracks T_{R1} to T_{R6} may actually have been formed on the disk 12, and have been squeezed due to, for example, effects of runout during the servo sector formatting process. For example, tracks T_{A1} to T_{A6} each have a smaller track width than T_{R1} to T_{R6}. Consequently, the track pitch illustrated between actual tracks T_{A1} to T_{A6} differs from the desired track pitch illustrated between reference tracks T_{R1} to T_{R6}.

The repository 408 may contain a listing of each of the track addresses (T_{A1}, to T_{A7}) and corresponding offset distances that the head 20 needs to be radially offset from the track centerline to at least substantially remove the squeeze (narrowness) present in tracks T_{A2} to T_{A6}. FIG. 7 illustrates an exemplary table of track addresses (T_{A1} to T_{A6}) and track offset distances (D₁ to D₅) that may be defined by the repository 408. The track offset distances D₁ to D₅ may each represent the same radial offset distance. To avoid squeezing tracks that are adjacent the actual tracks T_{A1} to T_{A6}, one or more of the actual tracks may be mapped out by a corresponding indication in the repository 408 so that the mapped out track(s) will not be used to store data (e.g., track T_{A6} has been mapped out by the indication “Not Used”). The remaining squeezed tracks (i.e., tracks T_{A2} to T_{A5}), which have not been mapped out, can then be expanded so as to use at least some of the radial disk space once reserved for the mapped out track(s) (i.e., track T_{A6}). Accordingly, mapping out one or more tracks among a group of squeezed tracks may allow the rest of the group of tracks to be adjusted so as to provide a desired track pitch therebetween. For example, for n squeezed tracks, a number k of those tracks may be mapped out so that the remaining squeezed tracks (n-k) can be adjusted, thereby recovering (n-k)/n tracks.

The track offset information for removing the squeeze in tracks T_{A1} to T_{A5} may be represented in the repository 408 more compactly by storing in the repository 408 the range of the squeezed group of tracks and the mapped out track(s). For example, if 10 tracks corresponding to track 100-110 were squeezed, the repository may store the information (100, 109, 110). The servo controller 406 can then determine from this information that track 110 has been mapped out and that the other tracks 100 to 109 are to be expanded by the radial distance (110-100)/109-100) or 1.11. Thus, to seek to track 105, the servo controller 406 positions the head 20 at the following shifted radial location to remove the effect of track squeeze:

$$shifted radial location for track 105 = 100 + \frac{[ ( 105 - 100 ) * ( 110 - 100 ) ]}{( 109 - 100 )} = 105.56 .$$

Accordingly, the LBA of a host read/write command is converted into a track address, which is used as a reference pointer in the repository 408 to determine the track offset distance and, therefrom, the shifted radial location of the track on the disk 12. Through a seek operation, the head 20 is positioned over the shifted radial location of the track while data is read from or written to the disk 12.

The track offset information may be developed and stored within the disk drive 10 during the manufacturing of the disk drive 10. For example, after a STW writes servo information on the disk 12 to define track locations, the pitch between the tracks across the disk 12 can be tested. When the pitch variation exceeds defined thresholds, track offset information can be defined for individual tracks and groups of tracks. Some tracks may be mapped out from use so that their space can be used for adjusting track pitch among other tracks.

FIG. 8 is a diagram that illustrates the desired reference tracks T_{R1} to T_{R6} and the actual tracks T_{A1} to T_{A6} having a single track misplacement. As shown in FIG. 8, actual tracks T_{A1}, T_{A2}, T_{A5}, and T_{A6} have the same width, while track T_{A3} is narrower and radially adjacent track T_{A4} is wider than the other tracks T_{A1}, T_{A2}, T_{A5}, and T_{A6}. Accordingly, only a single track T_{A3} is misplaced out of the group of tracks. As explained above, if the track pitch variation were left uncompensated, the performance of read/write operations to track T_{A3} may be significantly degraded and the reliability of read/write operations to track T_{A4} may be significantly decreased, along with other possible effects of carrying out read/write operations to those tracks. To compensate for the resulting radial pitch variation, an offset can be applied to track T_{A3} so as to expand its track width to correspond to the widths of tracks T_{A1}, T_{A2}, T_{A5}, and T_{A6}. The corresponding radial offset information stored in the repository 408 may identify the track number(s) that are to be widened. The servo controller 406 may then widen the identified track numbers and reduce the width of the radially adjacent next greater track address. Thus, with reference to FIG. 7, the repository 408 may identify track T_{A3}. The controller 408 can then increase the width of track T_{A3} and decrease the width of adjacent track T_{A4} by the same defined distance. A plurality of such individually misplaced tracks may thereby be separately defined in the repository 408 in this manner.

FIG. 9 is a diagram that illustrates the desired reference tracks T_{R1} to T_{R6} and actual tracks T_{A1} to T_{A6} having a repetitive pairs of track misplacement. As shown in FIG. 9, actual tracks T_{A1}, T_{A3}, and T_{A5} have narrow widths, while tracks T_{A2}, T_{A4}, and T_{A6} have expanded widths. Moreover, each narrow track is followed by a wide track in pairs that repeat as tracks T_{A1} and T_{A2}, T_{A3} and T_{A4}, T_{A5} and T_{A6}. The track pairs can thereby be efficiently represented in the repository 408 by an indication of the range of tracks over which offsets can be repetitively applied to compensate for the radial track variation. For example, if 10 tracks corresponding to track 100-110 were squeezed and stretched, the repository may identify information (100, 110). The servo controller 406 can then determine from this information that any host read/write commands to track addresses within the range of 100 to 110, that, beginning with track address 100, the head

alternately radially offset by 10% in a direction to increase the width of a track followed by a radial offset of 10% in an opposite direction to decrease the width of the next adjacent track to decrease the width of that track (i.e., increase width of tracks T_{A1}, T_{A3}, and T_{A5}, and decrease width of tracks T_{A2}, T_{A4}, and T_{A6}). Accordingly, track pitch variation among tracks T_{A1} to T_{A6} can be corrected without mapping out (removing from use) any of those tracks.

a diagram that illustrates the desired reference tracks T_{R1} to T_{R6} and actual tracks T_{A1} to T_{A6}, with track T_{A3} more narrow than the desired width of each of tracks T_{R1} to T_{A6}. The width of track T_{A3} may be expanded by mapping-out one of the other tracks (e.g., mapping out one of T_{R1}, T_{R2}, T_{R4}, T_{R5}, or T_{R6}) and shifting the tracks between track T_{A3} and the mapped out track to provide the desired width. Alternatively, when a nearby track is wider than the preferred width, the width of track T_{A3} can be expanded by shifting the tracks between track T_{A3} and the wider track so as to add the excessive width of the wider track to the narrow track. For example, if track T_{A7} (not shown) is sufficiently wider than the desired track width to allow expansion of track T₃, tracks T_{A4} to T_{A6} can be shifted toward track T_{A7} so that the track T_{A3} is widened and tracks T_{A4} to T_{A6} maintain the same width. The repository may represent this desired shifting by identifying track offset information that can include the address for T_{A3} and the address for T_{A6}. The servo controller 406 may then respond to the track offset information by shifting track T_{A4} to T_{A6} in a direction that expands track T_{A3} and narrows the track immediately following the defined range (i.e., narrows track T_{A7}). Accordingly, radial track pitch variation caused by the narrow track T_{A3} and by the wide track T_{A7} may be substantially removed by shifting some of the tracks as described.

As will be appreciated, one or more of the these processes may be carried out to compensate for radial track pitch variation. Moreover, some groups of tracks may be mapped out so as not to be used for data storage because of, for example, excessive track pitch variation, while other individual ones or groups of tracks may be shifted and/or selectively mapped out to allow compensation for track pitch variation associated with those tracks.

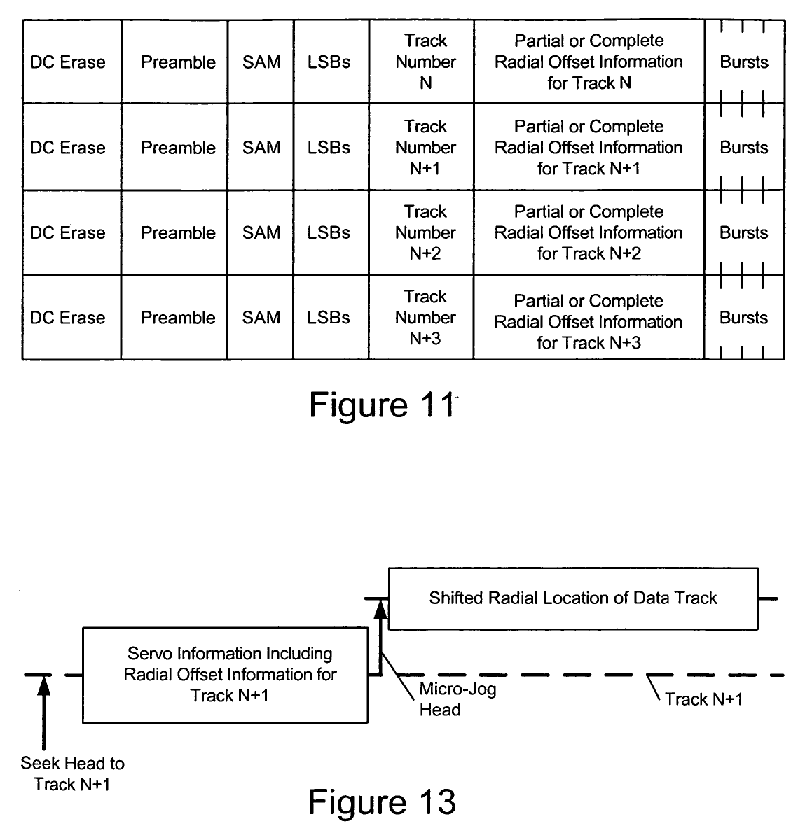

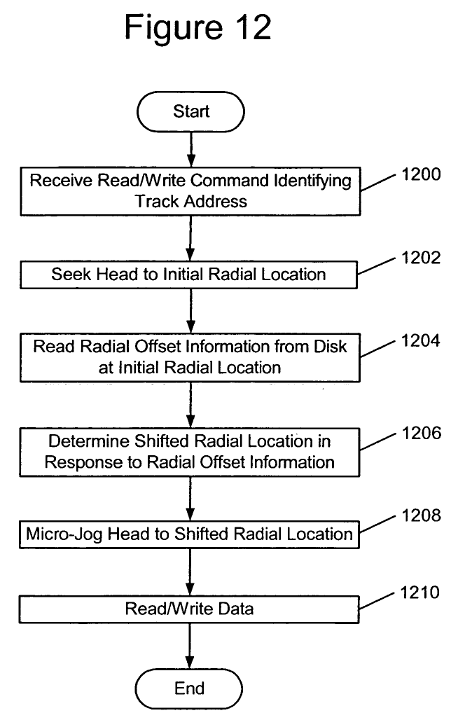

As explained above, the repository 408 may be consolidated at a defined location on the disk 12, in a semiconductor memory in the electronic circuits 30, and/or it may be distributed across the disk 12 with relevant portions of the radial offset information being aligned with the corresponding tracks. FIG. 11 illustrates an exemplary embodiment in which the radial offset information is distributed across the disk 12 within one or more of the servo sectors 44 and radially aligned with the corresponding data tracks. Accordingly, in this exemplary embodiment, the repository 408 is located on and distributed across the disk 12. As will be appreciated, the content and order of the servo information can vary from the exemplary embodiment shown in FIG. 11. FIG. 12 is a flowchart of operations that may be carried out by the servo controller 406 to respond to the radial offset information in the servo information, such as shown in FIG. 11, so as to at least partially compensate for radial pitch variation among tracks. FIG. 13 illustrates methods of micro-jogging the head 20 to a shifted radial location relative to an addressed track N+1 in response to radial offset information in the adjacent servo information, such as that shown in FIG. 11.

Referring to FIGS. 11-13, exemplary operations of the servo controller 406 will be described for at least partially compensating for radial pitch variation between some tracks. A read/write command is received (Block 1200) which identifies a track address (e.g., track number N+1 in FIG. 11) from which data is to be read/written on the disk 12. The servo controller 406 responds to the read/write command by seeking the head 20 to an initial radial location (Block 1202) that corresponds to the track address. One or more servo sectors 44 are read (Block 1204) to obtain the radial offset information for the track address (e.g., partial or complete radial offset information for track N+1). For example, the complete radial offset information may be stored in one or more of the servo sectors 44, or the partial information may distributed across a plurality of servo sectors 44 so that the plurality of sectors 44 need to be read to allow the controller 406 to generate complete radial offset information therefrom.

The controller 406 determines (Block 1206) a shifted radial location on the disk 12 to read/write data in response to the radial offset information that was read among the servo information. The controller 406 micro-jogs (Block 1208) the head 20 a determined radial distance to align the head 20 with the shifted radial location on the disk 12. Data is then read/written (Block 1210) on the disk 12 along the shifted radial location to carry out the host read/write command.

As will be appreciated, distributing partial portions of the radial offset information among a plurality of servo sectors 44 may decrease the amount of storage space needed in the each servo sector 44 for the radial offset information, however it may also result in a longer delay between when the head 20 arrives on track and when it can be micro-jogged to a final position to allow reading/writing along the shifted radial position.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A disk drive comprising:
a rotatable data storage disk including a plurality of radially distributed tracks, wherein radial pitch between at least some of the tracks varies across the disk;
a head that is configured to read/write data on the tracks;
an actuator that is configured to position the head relative to the disk; and
a controller that is configured to respond to a host read/write command identifying a track address on the disk by determining a corresponding shifted radial location on the disk that is radially offset from the actual location of the track address by a distance that at least partially compensates for the radial pitch variation between at least some of the tracks on the disk.

2. The disk drive of claim 1, wherein:
the radial offset information is stored at radial locations on the disk aligned with the tracks, and the radial offset information aligned with a selected track defines a radial distance that the head is to be moved from the selected track to at least partially compensate for the radial pitch variation between at least some of the tracks on the disk; and
the controller is further configured to respond to the track address of the host read/write command by controlling the actuator to seek the head to an initial radial location on the disk of the track address, to read radial offset information from the disk at the initial radial location, to determine the shifted radial location in response to the radial offset information, and to micro-jog the head to the determined shifted radial location.

3. The disk drive of claim 2, wherein the radial offset information is stored in at least one servo sector on the disk.

4. The disk drive of claim 3, wherein:
the radial offset information is distributed across a plurality of servo sectors on the disk; and
the controller is further configured to combine radial offset information read from a plurality of servo sectors to determine the radial offset distance that the head is to be moved from the selected track to the shifted radial location to at least partially compensate for the radial pitch variation between at least some of the tracks on the disk.

5. The disk drive of claim 1, further comprising a repository of radial offset information associated with a plurality of track addresses on the disk, and wherein the controller is further configured to respond to the track address of the host read/write command by accessing the repository to determine the shifted radial location on the disk that is radially offset from the actual location of the track address by a distance that at least partially compensates for the radial pitch variation between at least two tracks on the disk.

6. The disk drive of claim 5, wherein the repository of radial offset information is stored on the disk, and the controller is configured to read the repository from a defined location on the disk.

7. The disk drive of claim 5, wherein the repository defines radial offset information for each track address on the disk.

8. The disk drive of claim 5, wherein the controller is further configured to access the repository and determine the shifted radial location on the disk to position the head before seeking the head in response to the host read/write command.

9. The disk drive of claim 5, wherein the controller is further configured to begin seeking the head toward a target disk location corresponding to the track address identified by the host read/write command, and to modify the target disk location in response to the determination of the shifted radial location using the radial offset information from the repository.

10. The disk drive of claim 5, wherein:
at least some of the radial offset information in the repository defines a range of track addresses on the disk and a corresponding track shift distance for tracks within the defined range; and
the controller is further configured to determine the shifted radial location to read/write data on the disk based on the track shift distance defined in the repository when the track address of the host read/write command is within the range of track addresses defined in the repository.

11. The disk drive of claim 5, wherein:
at least some of the radial offset information in the repository defines a beginning track address, a first radial location on the disk for the beginning track address, an end track address, and a second radial location on the disk for the end track address; and
the controller is further configured to interpolate between the beginning and end track addresses and the first and second radial locations in response to the track address of the read/write command to determine the shifted radial location to read/write data on the disk to carry out the host read/write command.

12. The disk drive of claim 5, wherein:
at least some of the radial offset information in the repository defines a first plurality of track addresses and corresponding radial offset information for which the controller radially offsets the head a defined distance that expands track width for selected ones of the first plurality of addresses, and a second plurality of track addresses and corresponding radial offset information for which the controller radially offsets the head the defined distance in an opposite direction that narrows track width for selected ones of the second plurality of addresses.

13. The disk drive of claim 5, wherein:
at least some of the radial offset information in the repository defines a plurality of track addresses for which the controller radially offsets the head a defined distance in a direction that narrows track width for the plurality of track addresses and radially offsets the head the defined distance in an opposite direction that expands track width for tracks immediately adjacent to the plurality of track addresses.

14. The disk drive of claim 5, wherein:
at least some of the radial offset information in the repository defines a plurality of track addresses for which the controller radially offsets the head a defined distance in a direction that expands track width for the plurality of track addresses and radially offsets the head the defined distance in an opposite direction that narrows track width for tracks immediately adjacent to the plurality of track addresses.

15. The disk drive of claim 5, wherein:
at least some of the radial offset information in the repository defines a range of track addresses on the disk for which the controller alternates between radially offsetting the head a defined distance in a direction that expands track width and then radially offsetting the head the defined distance in an opposite direction that narrows track width for sequential tracks within the defined range of track addresses.

16. A method of positioning a head that is adjacent to a rotatable disk in a disk drive, the method comprising:
receiving a host read/write command identifying a track address on the disk; and
determining a shifted radial location on the disk that is radially offset from the actual location of the track address by a distance that at least partially compensates for the radial pitch variation between at least some of the tracks on the disk.

17. The method of claim 16, wherein determining a shifted radial location on the disk comprises:
controlling an actuator to seek the head to an initial radial location on the disk of the track address of the host read/write command;
reading radial offset information from the disk at the initial radial location;
determining the shifted radial location in response to the radial offset information; and micro-jogging the head to the determined shifted radial location

18. The method of claim 16, the disk drive further including a repository of radial offset information associated with a plurality of track addresses on the disk, and the method further comprising:
responding to the track address of the host read/write command by accessing the repository to determine the shifted radial location on the disk that is radially offset from the actual track address location by a distance that at least partially compensates for the radial pitch variation between at least two tracks on the disk.

19. The method of claim 18, further comprising:
initiating seeking of the head toward a target disk location corresponding to the actual location of the track address identified by the host read/write command; and
modifying the target disk location of the seek in response to the determination of the shifted radial location using the radial offset information from the repository.

20. The method of claim 18, wherein at least some of the radial offset information in the repository defines a range of track addresses on the disk and a corresponding track shift distance for tracks within the defined range, and the method further comprising:
determining the shifted radial location based on the track shift distance defined in the repository when the track address of the host read/write command is within the range of track addresses defined in the repository.

21. The method of claim 18, wherein at least some of the radial offset information in the repository defines a beginning track address, a first radial location on the disk for the beginning track address, an end track address, and a second radial location on the disk for the end track address, and the method further comprising:
interpolating between the beginning and end track addresses and the first and second radial locations in response to the track address of the read/write command to determine the shifted radial location to read/write data on the disk to carry out the host read/write command.

22. The method of claim 18, wherein at least some of the radial offset information in the repository defines a first plurality of track addresses and corresponding radial offset information and a second plurality of track addresses and corresponding radial offset information, and the method further comprising:
positioning the head a defined radial offset distance in a direction that narrows track width for selected ones of the first plurality of addresses, and positioning the head the defined radial offset distance in an opposite direction that expands track width for selected ones of the second plurality of addresses.

23. The method of claim 18, wherein at least some of the radial offset information in the repository defines a first plurality of track addresses and corresponding radial offset information and a second plurality of track addresses and corresponding radial offset information, and the method further comprising:
positioning the head a defined radial offset distance in a direction that expands track width for selected ones of the first plurality of addresses, and positioning the head the defined radial offset distance in an opposite direction that narrows track width for selected ones of the second plurality of addresses.

24. The method of claim 18, wherein at least some of the radial offset information in the repository defines a range of track addresses on the disk, and the method further comprising:
radially offsetting the head a defined distance in a direction that expands track width and then radially offsetting the head the defined distance in an opposite direction that narrows track width for sequential tracks within the defined range of track addresses.
